(19) United States
(12) Patent Application Publication
(10) Pub. No.: US 2015/0102932 A1
(43) Pub. Date: Apr. 16, 2015

(54) LEAK DETECTION SYSTEM AND METHOD

(71) Applicants: Bradley R. Miller, Cincinnati, OH (US); Daniel J. Smercina, Lebanon, OH (US); David Paulin, Toronto (CA)

(72) Inventors: Bradley R. Miller, Cincinnati, OH (US); Daniel J. Smercina, Lebanon, OH (US); David Paulin, Toronto (CA)

(21) Appl. No.: 14/512,770

(22) Filed: Oct. 13, 2014

Related U.S. Application Data
(60) Provisional application No. 61/890,527, filed on Oct. 14, 2013.

(51) Int. Cl. G08B 21/18; G01M 3/04

(52) U.S. Cl. CPC G08B 21/18; G01M 3/04
USPC 340/605

(57) ABSTRACT

A leak detection mat arrangement includes a base member configured to capture, direct and hold liquid while at the same time providing a support that is generally planar. The base member includes a bottom side and an upper side. The upper side includes a plurality of projecting portions separated by a plurality of recessed portions. When the bottom side of the base member is resting on a horizontal surface, the recessed portions are sloped to direct liquid toward a liquid capture zone of the upper side and the projecting portions have top edges that lie in a substantially horizontal common plane for stably supporting one or more items. At least one sensor is located in the liquid capture zone for detecting presence of liquid in the liquid capture zone.

### TECHNICAL FIELD

This application relates generally to leak detection and liquid capture, and more particularly, relates to a leak detection and liquid capture mat/liner system for use in residential households.

### BACKGROUND

In residential households, leaks can occur in numerous places, such as beneath sinks or home appliances in the nature of dishwashers, washing machines and hot water heaters. Most places where a leak can occur are hidden from casual observation and the homeowner's lack of awareness of a leak can lead to significant property damage. Leak detection devices have been suggested in the past, but no current satisfactory solution exists.

### SUMMARY

In one aspect, a leak detection and liquid capture mat includes a substantially central sloped interior upwardly facing surface with one or more liquid sensors substantially centrally located within the mat. The surface is sloped substantially central within the mat, while a plurality of upward projections from the upper surface of the mat have upper edges that lie in a common plane but are spaced apart so that liquid can flow into the lower portions of the surface of the mat. Power may be supplied to the mat and when a liquid is introduced the liquid contacts of one or more sensors cause the device to alert via audible alarm, integration into local wireless network, text message, automated message phone call or social media website. Simple audible alert mats may be upgraded to encompass additional alerts from original purchased design. The mat can be powered by a battery or multiple voltage power inputs.

In another aspect, a leak detection mat arrangement includes a base member configured to capture, direct and hold liquid while at the same time providing a support that is generally planar. The base member includes a bottom side and an upper side. The upper side includes a plurality of projecting portions separated by a plurality of recessed portions. When the bottom side of the base member is resting on a horizontal surface, the recessed portions are sloped to direct liquid toward a liquid capture zone of the upper side and the projecting portions have top edges that lie in a substantially horizontal common plane for stably supporting one or more items while at the same time providing clearance between the items and the recessed portions of the base member that will allow liquid to flow beneath the items along the recessed portions to the liquid capture zone. At least one sensor is located in the liquid capture zone for detecting presence of liquid in the liquid capture zone. A leak detection alert is associated with the at least one sensor to provide an alert signal in response to the at least one sensor detecting presence of liquid in the liquid capture zone.

In one implementation, the leak detection alert comprises a device that produces one or more of (i) an audible alarm, (ii) a visual alert or (iii) an electrical or electronic communication signal. The electrical or electronic communication signal may trigger one or more of a wireless network signal, a text message, an automated phone call message, or a social media website message.

In one implementation, the liquid capture zone is substantially centrally located on the base member.

In one implementation, the plurality of projections are elongated and extend inward from a perimeter of the base member.

In one implementation, the base member is formed of a flexible material and the plurality of recesses are elongated and are arranged to permit the base member to be rolled up on itself into a spiraled tubular form.

In one implementation, the perimeter of the base portion is defined by a rim that has an upper surface in the common plane.

In one implementation, the bottom side of the base member includes multiple projections and multiple recessed portions, wherein the projections on the bottom side have lower edges that lie in a common plane to collectively support the base member.

In one implementation, the base member includes a pocket holding a removable alert assembly that includes the leak detection alert and a power source within a housing.

In one implementation, the housing includes a compartment and a lid, the lid having at least one portion that can be moved for accessing the power source.

In one implementation, the alert assembly includes an audible annunciator and an accessible test button that triggers the audible annunciator.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic top plan view of one embodiment of mat arrangement;

FIG. 2 is a schematic side elevation of the mat of FIG. 1;

FIG. 3 is a top perspective view of another embodiment of a mat arrangement;

FIG. 4 is a bottom perspective view of the mat arrangement of FIG. 3;

FIG. 5 is a top plan view of the mat arrangement of FIG. 3;

FIG. 6 is a partial perspective view of a package arrangement for the mat of FIG. 3; and

FIG. 7 is a perspective view of an alert assembly that is locatable within a pocket of the mat arrangement of FIG. 3.

### DETAILED DESCRIPTION

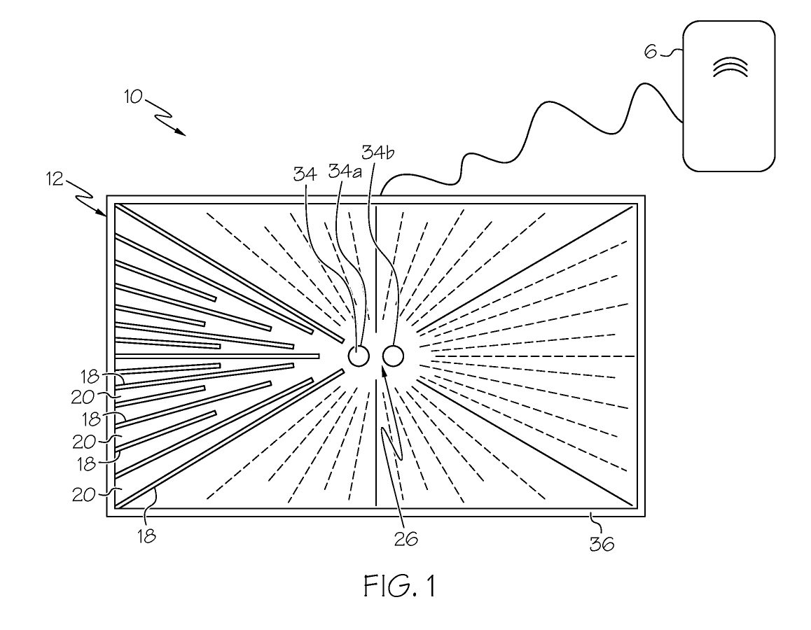

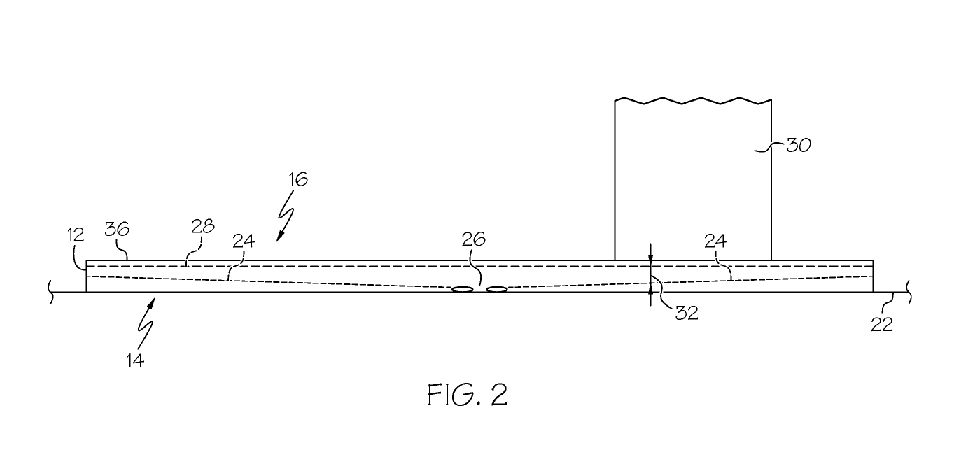

Referring to FIGS. 1 and 2, a leak detection mat arrangement 10 includes a base member 12 configured to capture, direct and hold liquid while at the same time providing a support that is generally planar. The base member acts as a substrate of the arrangement to capture and hold liquid. Overall height of the mat member may, by way of example, be on the order of about one-half inch to one inch, though variations are possible. The mat member may, by way of example, range from 4″-36″ in length and 3″-24″ in width and may be substantially flat and flexible (e.g., formed of a molded plastic material). However, variations in size and material are possible.

The base member includes a bottom side 14 and an upper side 16. The upper side includes a plurality of upwardly projecting portions 18 (e.g., rib type projections) separated by a plurality of recessed portions 20. When the bottom side of the base member is resting on a horizontal surface (e.g., 22), the recessed portions 20 are sloped (as indicate by dashed lines 24 in FIG. 2) to direct liquid toward a liquid capture zone 26 of the upper side. On the other hand, the projecting portions have top edges or surfaces that lie in a substantially horizontal common plane (as indicated by dashed line 28 in FIG. 2) for stably supporting one or more items 30. This arrangement provides clearance 32 between the items and the recessed portions of the base member so as to allow liquid to flow beneath the items 30 along the recessed portions toward the liquid capture zone 26. In the illustrated embodiment the projections are shown as having a relatively uniform width in the top view of FIG. 1, with some projections extending from the perimeter all the way to the capture zone 26, and other projections extending only part of the way to the capture zone. However, variations in projection configuration are possible, including projections the progressively narrow in width when moving from the perimeter end toward the capture zone.

At least one sensor 34 is located in the liquid capture zone 26 for detecting presence of liquid in the liquid capture zone. By way of example, the sensor 34 may be formed by spaced apart contacts 34a and 34b of a circuit, where liquid in the capture zone allows current to flow between the contacts and thus closes a circuit. However, the sensor could be a mechanical float type switch or any other type of sensor arranged to detect the liquid. A leak detection alert device 6 is associated with the at least one sensor to provide an alert signal in response to the at least one sensor detecting presence of liquid in the liquid capture zone. In a simplest embodiment the alert 6 may be an audio annunciator that generates an audible alarm signal (e.g., buzzer or tone). However, other variations are possible. Thus, the leak detection alert 6 may be a device that produces one or more of (i) an audible alarm, (ii) a visual alert or (iii) an electrical or electronic communication signal. The electrical or electronic communication signal may, for example, trigger one or more of a wireless network signal, a text message, an automated phone call message, or a social media website message. The sensor(s) 34 and alert 6 may be battery powered and/or connectable to external voltage sources via suitable power ports. Exemplary types of power sources may include 9v battery, 12v and 115v. By way of example, a battery compartment or power port may be incorporated into the mat itself or into the alert device 6.

In the illustrated embodiment of FIGS. 1 and 2, the liquid capture zone 26 is substantially centrally located on the base member, which is rectangular in configuration. The plurality of projections 18 and the plurality of recesses 20 are generally elongated and extend from locations at or proximate a perimeter 36 of the base member and toward the liquid capture zone 26. The perimeter 36 of the base portion may be defined by a relatively narrow rim that projects above the substantially horizontal common plane 28 as suggested in FIG. 2. However, the top of the rim could also lie in the common plane 28.

While the alert device is shown in FIGS. 1 and 2 as being formed separately from the mat, the alert device could be integrated with the mat (e.g., a small speaker compartment included in an edge of the mat).

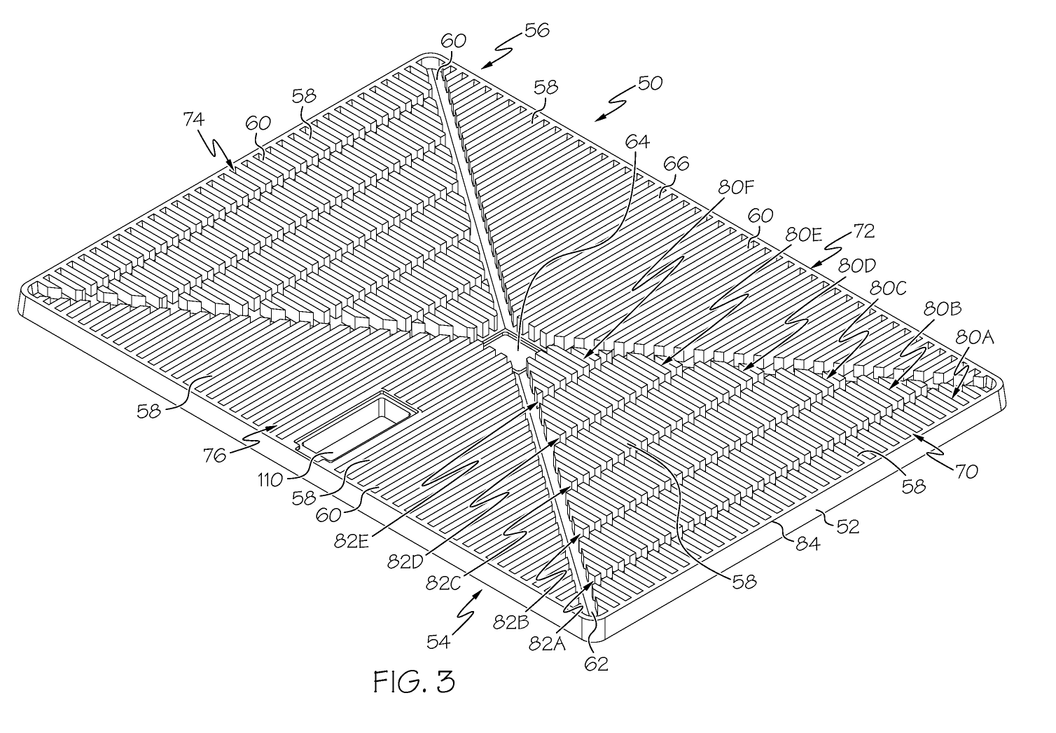

Referring now to FIGS. 3-5, an alternative embodiment of a mat arrangement 50 is shown. The mat arrangement includes a base member 52 configured to capture, direct and hold liquid, while at the same time providing a support that is generally planar. In this regard, the base member 52 includes a bottom side 54 and an upper side 56. The upper side 56 includes a plurality of projecting portions 58 separated by a plurality of recessed portions 60, the bottom surfaces of the recessed portions together defining a flow capture and direction surface 62. When the bottom side 54 of the base member 52 is resting on a horizontal surface, the flow capture and direction surface 62 is generally sloped to direct liquid toward a liquid capture zone 64 of the upper side, and the projecting portions 58 have top edges or surfaces 66 that lie in a substantially horizontal common plane for stably supporting one or more items (not shown). The spacing between the supporting plane and the flow capture and direction surface 62 provides clearance between the supported items and captured liquid that will allow liquid to flow beneath the items to the liquid capture zone.

The surrounding rim 84 of the base member 52 includes an upper surface that lies in common plane with the upper surfaces of the projections 58, and multiple projections 58 intersect and extend from the rim 84. As shown, the projections 58 are positioned in one of four generally triangular zones 70, 72, 74 and 76 that are separated by diagonally extending recessed portions 62 that extend to zone 64. The projections 58 in zones 72 and 76 are generally continuous in length within such zones, while the projections 58 in zones 70 and 74 are broken up into distinct rows, such as rows 80A-80F in zone 70, with recessed portions 82A-82E between such rows.

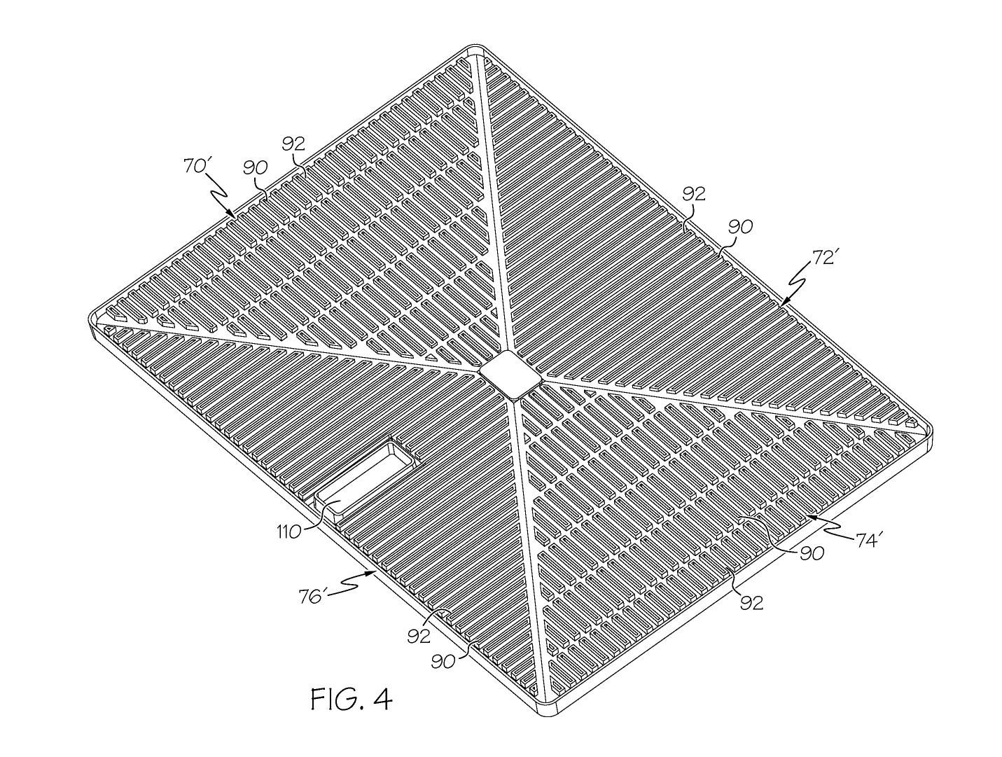

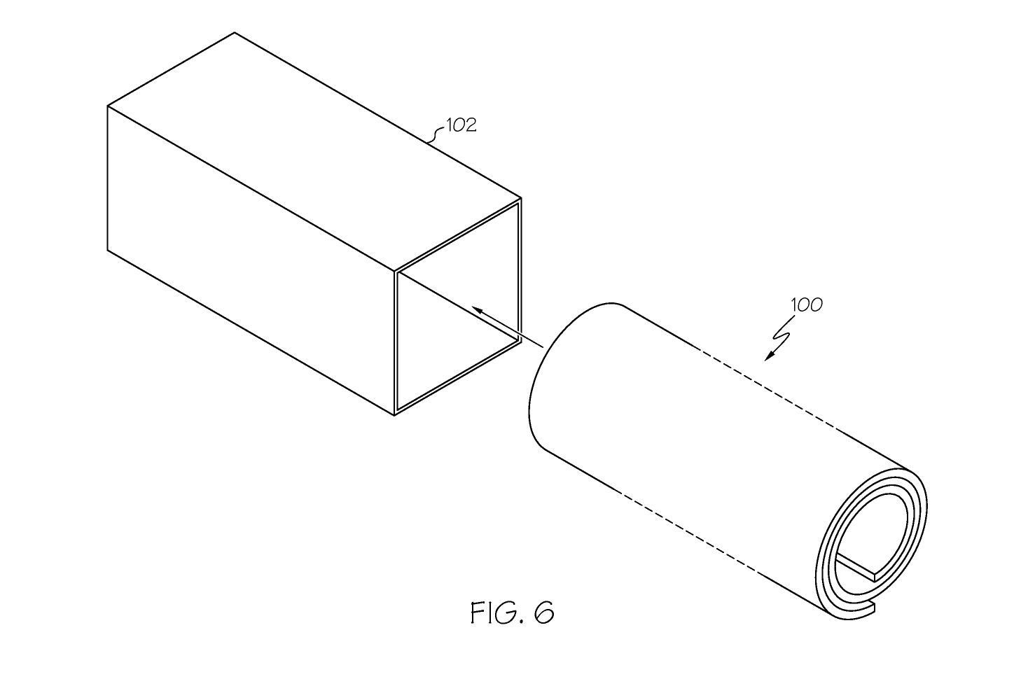

As seen in FIG. 4, the bottom side 54 of the base member also includes projections 90 and recesses 92 having a similar arrangement to that of the upper side. The bottom side projections 90 align with the upper side projections 58 and are open such that passages 94 upward through the bottom side projections 90 and into the upper side projections 58 are formed. The bottom side projections 90 have lower edges that lie in a common plane so that the bottom side projections 90 collectively support the base member when in its use orientation. As shown, the bottom side projections are also arranged in four substantially triangular zones 70′, 72′, 74′ and 76′. The bottom side projections in zones 70′ and 74′ are arranged in multiple rows, similar to that described above for the top side.

Where the base member is made of a suitably flexible material (e.g., plasticized PVC) the base member can, advantageously, be rolled up for the purpose of packaging and transport. In the illustrated embodiment of FIGS. 3-5, the spacing between the projection rows in zones 70 and 74 at the upper side, and the similar spacing in the projection rows in zones 70′ and 74′ at the bottom side, in combination with the recessed portions 60 between the projections 58 in zones 72 and 76 at the upper side and the recessed portions 92 between the projections 90 in zones 72′ and 76′ at the bottom side, facilitate the rolling operation. A rolled base member 100 (e.g., per the schematic depiction in FIG. 6) can be inserted into an elongated rectangular box 102 or other suitable packaging (e.g., such as a tubular bag or a tubular shrink-wrap material). The base member is simply unrolled by a consumer after purchase and unpackaging for use. However, more rigid embodiments of the base member are also possible.

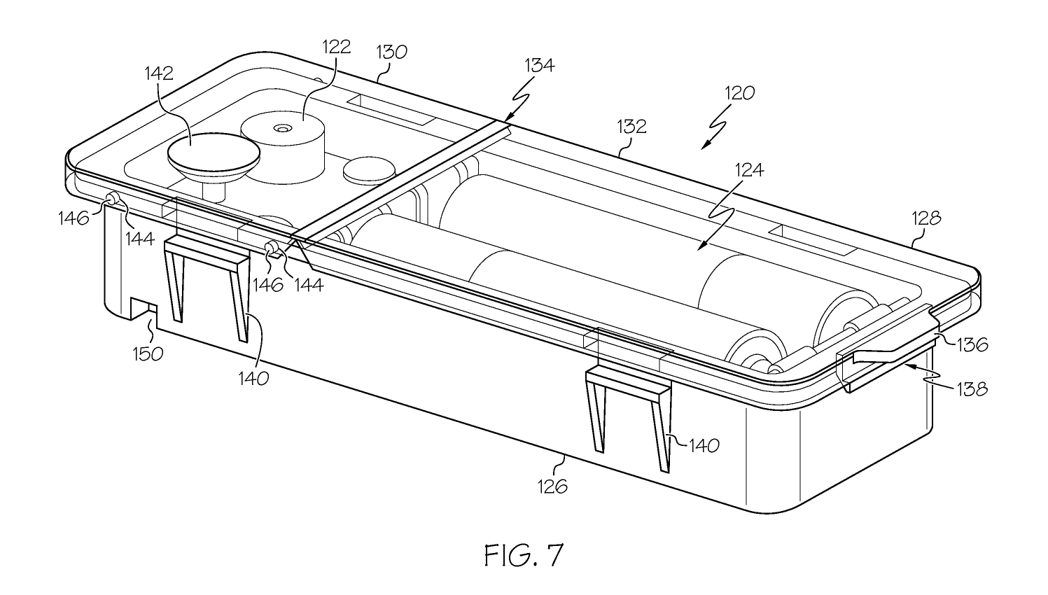

The base member 50 may be molded as a monolithic, unitary structure (e.g., of plasticized PVC or other suitable material, which could include recycled material). In this regard, the base member 50 includes a pocket 110 formed therein that is used to contain an alert assembly 120 (see FIG. 7) that may include an alert device 122 (e.g., tone generator, buzzer or other audio generator) on one side and associated power source 124 (e.g., batteries) on another side of an internal compartment formed between compartment 126 and a removable lid 128 (shown in FIG. 7 as clear plastic so that internal components of the assembly can be viewed). In the illustrated embodiment the lid includes two portions 130 and 132, with a hinge 134 (e.g., living or pivot) therebetween that allows lid portion 132 to be flipped up (e.g., using grip tab 136) for battery replacement. A latch arrangement 138 (e.g., a lip on the rim of the compartment 126 and a corresponding lip below the grip tab 136, where the lips slide over each other into a latching condition upon closure of lid portion 132) may be provided to hold lid portion 132 down during normal use. Likewise, the compartment 126 may include side tabs 140 that interact with structure of the pocket 110 to releasably hold the alert assembly 120 in place within the pocket 110. Moreover, portion 130 of the lid may include side slots 144 that engage projecting pins 146 of the base in a snap-fit arrangement. A test button 142 may be accessible through an opening in lid portion 130, to enable testing of the alert device 122.

The alert assembly 120 may either be located within the pocket 110 when the base member is rolled for packaging, or the alert assembly may be maintained as a separate unit that is also loaded into the elongated rectangular box 102 or other packaging.

When the alert assembly 120 is installed on the base member 50 for use, electrical leads (not shown) may run from the assembly 120 through an opening 150 in the compartment 126 and extend to the capture or collection zone 64, with the leads having spaced apart contacts (not shown) that form a sensor for detecting liquid captured in zone 64. In this regard, the leads may pass along the bottom side of the base member 50 and then back up through the base member 50 to the upper side in or near zone 64 or may alternatively extend along the upper side of the base member 50 (e.g., along the recessed portions of the upper side).

As an alternative to the pocket 110, the base member may include an integral compartment that holds an alert device. The compartment may be accessible via a movable flap, and may also include a space for holding a power source such as a battery.

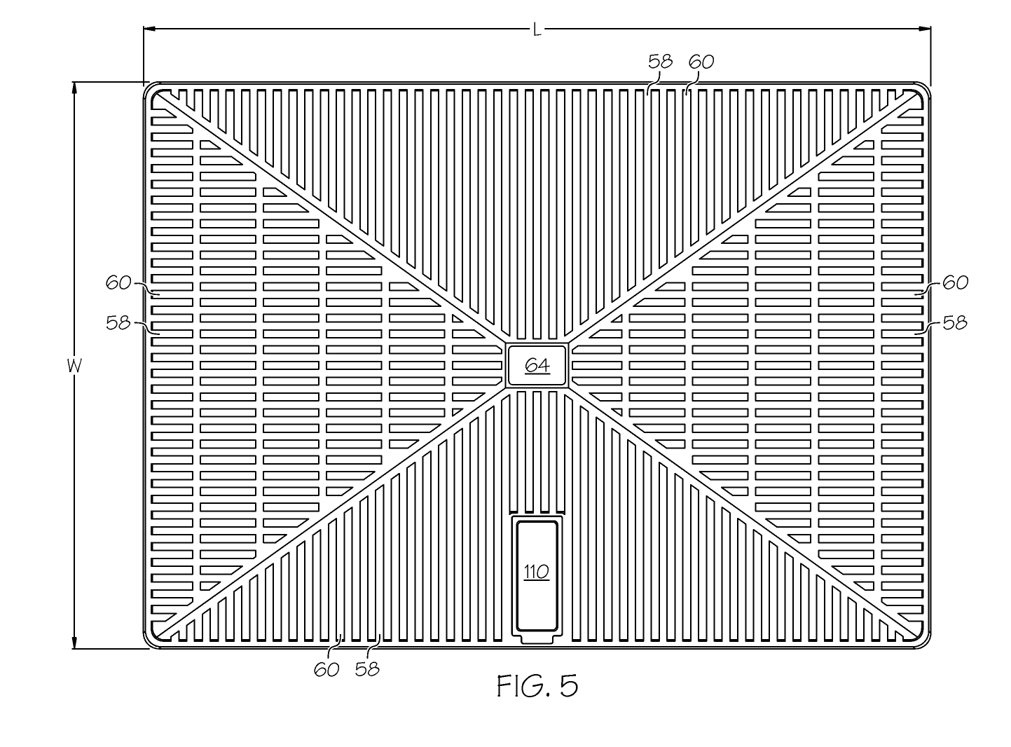

In one embodiment, the base member 50 has footprint dimensions (e.g., as seen in the top view of FIG. 5) of between about 29″ and 31″ long (L) and between about 22″ and about 24″ wide (W), such as about 30″×23.5″, suitable for location within a cabinet under a kitchen sink. In another embodiment, the base member may be dimensioned between about 23″ and about 26″ long (L) and between about 17″ and about 19″ wide (W), such as about 25″ by 18″, suitable for location within a cabinet under a bathroom sink. The total height of the base member may be between about 5/16″ and about 1″, such as between about ½″ inch and about ⅝″ (e.g., about 9/16″). However, numerous variations on footprint size and height are possible as previously noted. The recessed portions of the upper side of the base member 50 may in combination be capable of holding of a volume of between about 40 fluid ounces and 80 fluid ounces, such as about 50 to 70 ounces, though other variations are possible.

It is to be clearly understood that the above description is intended by way of illustration and example only, is not intended to be taken by way of limitation, and that other changes and modifications are possible. For example, while certain alert types and features have been described, alert features may also be facilitated through the use of a local Wi-Fi network and may be upgraded to include premium alert features and future communication mediums.

What is claimed is:

1. A leak detection mat arrangement, comprising:
a base member configured to capture, direct and hold liquid while at the same time providing a support that is generally planar, the base member including a bottom side and an upper side, the upper side including a plurality of projecting portions separated by a plurality of recessed portions, wherein when the bottom side of the base member is resting on a horizontal surface the recessed portions are sloped to direct liquid toward a liquid capture zone of the upper side and the projecting portions have top edges that lie in a substantially horizontal common plane for stably supporting one or more items while at the same time providing clearance between the items and the recessed portions of the base member that will allow liquid to flow beneath the items along the recessed portions to the liquid capture zone;
at least one sensor located in the liquid capture zone for detecting presence of liquid in the liquid capture zone; and
a leak detection alert associated with the at least one sensor to provide an alert signal in response to the at least one sensor detecting presence of liquid in the liquid capture zone.

2. The leak detection mat arrangement of claim 1 wherein the leak detection alert comprises a device that produces one or more of (i) an audible alarm, (ii) a visual alert or (iii) an electrical or electronic communication signal.

3. The leak detection mat arrangement of claim 2 wherein the electrical or electronic communication signal triggers one or more of a wireless network signal, a text message, an automated phone call message, or a social media website message.

4. The leak detection mat arrangement of claim 1 wherein the liquid capture zone is substantially centrally located on the base member.

5. The leak detection mat arrangement of claim 4 wherein the plurality of projections are elongated and extend inward from a perimeter of the base member.

6. The leak detection mat arrangement of claim 5 wherein the base member is formed of a flexible material and the plurality of recesses are elongated and are arranged to permit the base member to be rolled up on itself into a spiraled tubular form.

7. The leak detection mat arrangement of claim 1 wherein the perimeter of the base portion is defined by a rim that has an upper surface in the common plane.

8. The leak detection mat arrangement of claim 1 wherein the bottom side of the base member includes multiple projections and multiple recessed portions, wherein the projections on the bottom side have lower edges that lie in a common plane to collectively support the base member.

9. The leak detection mat arrangement of claim 1 wherein the base member includes a pocket holding a removable alert assembly that includes the leak detection alert and a power source within a housing.

10. The leak detection mat arrangement of claim 9 wherein the housing includes a compartment and a lid, the lid having at least one portion that can be moved for accessing the power source.

11. The leak detection arrangement of claim 9 wherein the alert assembly includes an audible annunciator and accessible test button that triggers the audible annunciator.

12. The leak detection arrangement of claim 1 wherein the base member includes an integral compartment that holds the leak detection alert.

13. The leak detection arrangement of claim 12 wherein the compartment includes a space for holding a power source.

14. A package assembly, comprising:
an elongated package material;
a mat base member in a rolled configuration and positioned within the package material, the mat base member including a bottom side and an upper side, the upper side including a plurality of projecting portions separated by a plurality of recessed portions, wherein when the mat base member is in an unrolled configuration the projecting portions have top edges that lie in a substantially horizontal common plane;
a sensor within the package material for positioning within a liquid collection zone of the upper side of the rolled mat base member; and
an alert device within the package material and configured for connection with the sensor, the alert device comprising a device for producing one or more of (i) an audible alarm, (ii) a visual alert or (iii) an electrical or electronic communication signal responsive to the sensor.

15. The package assembly of claim 14 wherein the mat base member includes a pocket, a removable alert assembly is within the package material and includes the alert device and a battery compartment within a housing, the housing shaped and sized for insertion within the pocket.

16. The package assembly of claim 14 wherein the package material is a box.

17. A leak detection mat arrangement, comprising:
a substrate that captures and holds liquid at its upper side;
at least one sensor for detecting liquid captured by the substrate;
a leak detection alert device connected to sensor;
a power source connected to power the sensor and the alert device;
a recessed surface at the upper side of the substrate to enable liquid flow toward the sensor; and
a support surface at the upper side of the substrate and formed by multiple projections having upper sides in a common, substantially horizontal support plane to allow liquid to flow into the recessed surface from or through the support plane.

18. The leak detection mat arrangement of claim 17 wherein the leak detection alert device produces one or more of an audible alarm, a wireless network signal, a text message, an automated message phone call or a social media website alert.

19. The leak detection mat arrangement of claim 17 wherein the recessed surface is formed with a slope within to direct liquid toward the sensor.
